(19) United States
(12) Patent Application Publication
(10) Pub. No.: US 2011/0310894 A1
(43) Pub. Date: Dec. 22, 2011

(54) Network system, network control device and control method

(75) Inventor: Shuichi Karino, Tokyo (JP)

(73) Assignee: NEC CORPORATION, Tokyo (JP)

(21) Appl. No.: 13/137,541

(22) Filed: Aug. 24, 2011

(30) Foreign Application Priority Data
Dec. 17, 2009 (JP) 2009-286188
Dec. 14, 2010 (JP) PCT/JP2010/072439

(51) Int. Cl. H04L 12/56

(52) U.S. Cl. 370/389

(57) ABSTRACT

A module train determination block determines a module block being composed of at least one of a plurality of control application modules having different network control functions respectively. A plurality of attached data prepared for the plurality of control application modules are used. Each of the plurality of attached data indicates an operational parameter being referred or rewritten when the operation determined by a corresponding control application module is executed. The module train determination block refers to each attached data and determines a module train whose consistency is insured. A scheduling block executes the module train in turn and generates a single entry setting data indicating a sequence of the operation which corresponds to a sequence of network control devices.

### CROSS-REFERENCE TO RELATED APPLICATION

This is a continuation application of International Application No. PCT/JP2010/072439, filed on Dec. 14, 2010.

### TECHNICAL FIELD

The present invention relates to a technique of a controlling network apparatus in a network system. In particular, the present invention relates to a technique of controlling a network apparatus that performs packet processing according to a packet processing table.

### BACKGROUND ART

FIG. 1 is a conceptual diagram for describing the Open flow technique described in Non-patent literature 1. In the open flow, path control, failure recovery, load distribution and optimization are performed in unit of flow. In the open flow, the open flow switch (SW) that functions as a transfer node and the open flow controller (Controller) that controls the open flow switch are used.

The open flow switch has a flow table representing correspondence between “match condition” and “action” and operates according to the flow table. Specifically, when receiving a packet, the open flow switch refers to the flow table and retrieves an entry matching the received packet from the flow table. When the entry matching the received packet is recorded in the flow table, the open flow switch applies processing designated by the action of the matching entry to the received packet. Typically, the open flow switch transfers the received packet to an output port designated by the action.

The open flow controller sets contents of the flow table of the open flow switch. In other words, the open flow controller is capable of instructing the open flow switch to add a new entry, changing and deleting an entry, thereby controlling operation of the open flow switch.

For example, considering that a certain open flow switch receives a packet in a certain flow and no entry matching the received packet is found in the flow table. Such received packet is hereinafter referred to as a “first packet”. In this case, the open flow switch transmits the first packet to the open flow controller. In response to the first packet, the open flow controller determines contents of processing applied to a packet train in the flow, which includes the first packet as a leading packet. That is, the open flow controller determines the open flow switches required to the processing of the flow and a new entry ought to be set to the respective flow tables. Then, the open flow controller instructs each of the required open flow switches to add the new entry. When receiving the instruction, each of the open flow switches adds the new entry to its own flow table. Then, the open flow controller returns the first packet to the open flow switch. After that, the first packet and subsequent packets in the same flow are processed according to the new entry. In other words, these packets are processed by the corresponding open flow switches at high speed without passing through the open flow controller.

Here, the open flow controller has various applications having different network control functions. The open flow controller is able to variously set the contents of processing applied to the flow by executing the applications as desired. This enables flexible and highly extendible network control.

Examples of the various network control functions include “shortest path switching” and “NAPT (Network Address Port Translation)” The “shortest path switching” serves to achieve packet transmission through a shortest path. Specifically, the “shortest path switching” designs a shortest path to the destination address of a packet, determines an entry that achieves packet transmission through the shortest path and sets the entry to each switch on the shortest path. The “NAPT” sets an entry that designates address/port conversion. This allows a specific switch to act as an NAPT device for a specific flow.

### CITATION LIST

### Non-Patent Literature

[NPTL1] Nick McKeown et al., “Open Flow: Enabling Innovation in Campus Networks”, ACM SIGCOMM Computer Communication Review, Vol. 38, No. 2, 2008 (http://www.openflowswitch.org//documents/openflow-wp-latest.pdf)

### DISCLOSURE OF INVENTION

It is considered to combine a plurality of network control functions and apply the combined functions to the same flow. For example, given that the above-mentioned “NAPT” and “shortest path switching” are combined to each other and applied to the same flow. FIG. 2 shows an example of entries in the flow table set in this case.

As shown in FIG. 2, each entry in the flow table indicates “match condition” and “action”. In the example shown in FIG. 2, the match condition includes a combination of an originating IP address, an originating port number, a destination IP address and a destination port number. The match conditions of an entry A and an entry B are the same as each other, which means that the entry A and the entry B indicates contents of processing applied to the packets in the same flow. The entry A is set according to the “NAPT”, in which it is designated that the originating IP address is converted into “10.56.1.10” and the originating port number is converted into “49817”. Meanwhile, the entry B is set according to the “shortest path switching”, in which a “port 3” is designated as destination of the received packet.

However, the entry A and the entry B in FIG. 2 are independently set according to the “NAPT” and the “shortest path switching”, respectively. That is, the entry A and the entry B are set independently from each other without considering the combination of the “NAPT” and the “shortest path switching”. In this case, the following problem occurs.

Considering that, upon reception of a packet in the flow, the entry A is first hit. In this case, the originating IP address and the originating port number of the received packet are rewritten. Accordingly, the entry B is not hit thereafter. In other words, the received packet is not transmitted to the desired destination. On the other hand, if the entry B is first hit, the packet is transmitted with the address being unconverted. In this manner, desired packet processing using the combination of the “NAPT” and the “shortest path switching” cannot be achieved.

More generally, a table for designating the contents of processing applied to a packet, such as the flow table, a route table or a packet filter, is hereinafter referred to as a “packet processing table”. An apparatus that has the packet processing table and executes packet processing according to the packet processing table is hereinafter referred to as “network apparatus”. A device that controls operation of the network apparatus by determining the contents of the packet processing table, that is, performs network control is hereinafter referred to as a “network control device”.

An object of the present invention is to provide a technique capable of setting a packet processing table so that packet processing corresponding to a combination of a plurality of network control functions can be achieved without inconsistency when a network control device applies the combination of the network control functions to a same flow.

According to an aspect of the present invention, a network system is provided. The network system includes a network apparatus having a packet processing table; and a network control device connected to the network apparatus. Each entry of the packet processing table indicates a match condition and an operation executed on a packet being matched to the match condition. The network apparatus sets each entry in response to an entry setting data transmitted from the network control device. The network apparatus refers to the packet processing table when receiving the packet, and executes the operation designated by a certain entry in the packet processing table on the received packet when the received packet is matched to the match condition of the certain entry.

The network control device includes: a plurality of control application modules; a module train determination block; a scheduling block; a table setting block; and a storage device. The plurality of control application modules has a plurality of network control functions different from each other respectively, and determines a content of the operation correspondingly to the plurality of network control functions. The module train determination block determines a module train. The module train is composed of at least one of the plurality of control application modules and has a sequence of network control functions applied to a target packet. The scheduling block executes the module train in turn and generates a single entry setting data indicating a sequence of the operation which corresponds to the sequence of network control devices. The table setting block transmits the single entry setting data to the network apparatus.

The storage device stores a plurality of attached data relating to the plurality of control application modules respectively. Each of the plurality of attached data indicates an operational parameter being referred or rewritten when the operation determined by a corresponding control application module among the plurality of control application modules is executed. The module train determination block determines the module train such that an inconsistency does not occur in the sequence of operations which are executed on the target packet by referring to each attached data.

According to another aspect of the present invention, a network control device is provided. The network control device is connected to a network apparatus to compose the network system according to an aspect of the present invention.

According to further another aspect of the present invention, a control method of a network apparatus is provided. The network apparatus has a packet processing table. Each entry of the packet processing table indicates a match condition and an operation executed on a packet being matched to the match condition. The network apparatus sets each entry in response to an entry setting data transmitted from the network control device. The network apparatus refers to the packet processing table when receiving the packet, and executes the operation designated by a certain entry in the packet processing table on the received packet when the received packet is matched to the match condition of the certain entry. A plurality of control application modules included in the network control device have a plurality of network control functions different from each other respectively, and determines a content of the operation correspondingly to the plurality of network control functions.

The control method includes: (A) a step of determining a module train being composed of at least one of the plurality of control application modules and has a sequence of network control functions applied to a target packet; (B) a step of executing the module train in turn and generating a single entry setting data indicating a sequence of operation which corresponds to the sequence of network control devices; and (C) a step of transmitting the single entry setting data to the network apparatus. (A) The step of determining the module train includes: (A1) a step of reading out a plurality of attached data relating to the plurality of control application modules respectively, wherein each of the plurality of attached data indicates an operational parameter being referred or rewritten when the operation determined by a corresponding control application module among the plurality of control application modules is executed, and (A2) a step of executing determination of the module train such that an inconsistency does not occur in the sequence of operations which are executed on the target packet by referring to each attached data.

According to further another aspect of the present invention, a computer-readable non-transitory medium having executable code to cause a computer of a network control device to execute control processing of a network apparatus is provided. By this control processing, a control method of the network apparatus according to an aspect of the present invention is realized.

According to the present invention, it is possible to set a packet processing table so that packet processing corresponding to a combination of a plurality of network control functions can be achieved without inconsistency when a network control device applies the combination of the network control functions to a same flow.

### BRIEF DESCRIPTION OF DRAWINGS

The above-mentioned and other objects, advantages and features will become more apparent from some exemplary embodiments of the present invention which are described in conjunction with the following figures, in which:

FIG. 1 is a conceptual diagram for describing open flow;

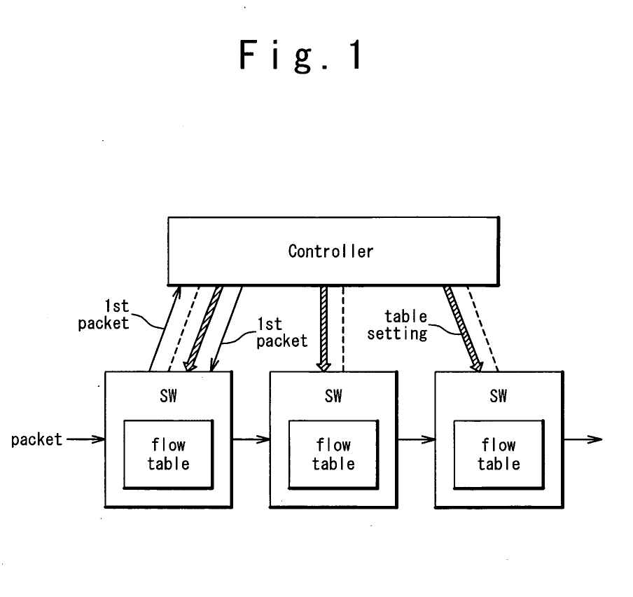

FIG. 2 is a view showing an example of entries set in a flow table;

FIG. 3 is a block diagram showing an example of a configuration of a network system according to an embodiment of the present invention;

FIG. 4 is a block diagram showing an example of a configuration of a network apparatus according to the present embodiment;

FIG. 5 is a conceptual diagram showing a packet processing table according to the present embodiment;

FIG. 6 is a flow chart showing processing in the network apparatus according to the present embodiment;

FIG. 7 is a block diagram showing an example of a configuration of a network control device according to the present embodiment;

FIG. 8 is a conceptual diagram for describing a module train according to the present embodiment;

FIG. 9 is a flowchart showing Step S100 (network control processing) according to the present embodiment;

FIG. 10 is a conceptual diagram showing attached data according to the present embodiment;

FIG. 11 is a conceptual diagram for describing Step S110 (determination of module train) according to the present embodiment;

FIG. 12 is a flow chart showing Step S110 (determination of module train) according to the present embodiment;

FIG. 13 is a conceptual diagram for describing Step S113 (checking processing) according to the present embodiment;

FIG. 14 is a conceptual diagram for describing Step S113 (checking processing) according to the present embodiment;

FIG. 15 is a conceptual diagram for describing Step S113 (checking processing) according to the present embodiment; and

FIG. 16 is a conceptual diagram for describing Step S113 (checking processing) according to the present embodiment.

### DESCRIPTION OF EMBODIMENTS

Some exemplary embodiments of the present invention will be described below referring to the accompanying drawings.

### 1. Network System

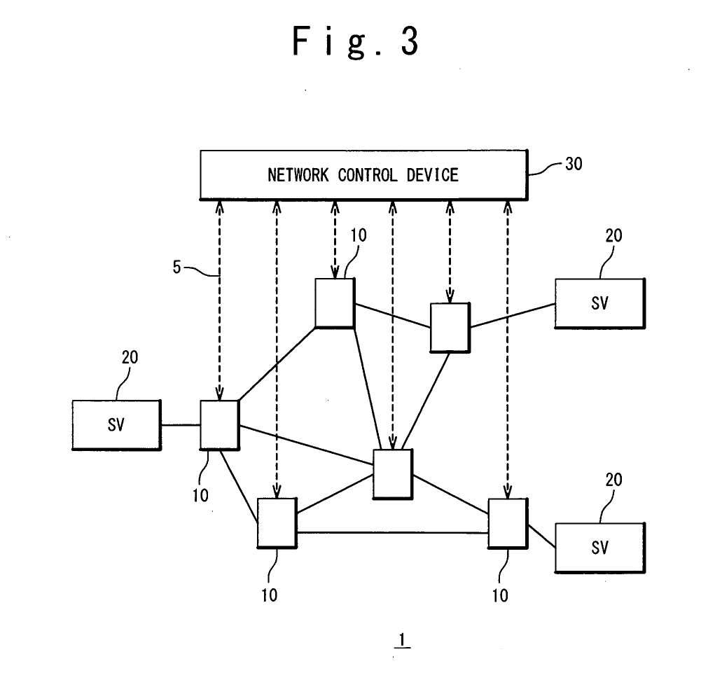

FIG. 3 is a block diagram showing an example of a configuration of a network system 1 according to the present exemplary embodiment. The network system 1 includes network apparatuses 10, servers 20 and a network control device 30.

The network apparatus 10 is typically, a switch having a flow table or a router having a route table. The network apparatus 10 may also be a firewall having a packet filter. The flow table, the route table and the packet filter designate contents of processing applied to a packet, and hereinafter are collectively referred to as a “packet processing table”. That is, the network apparatus 10 has the packet processing table and executes packet processing according to the packet processing table.

The network control device 30 determines contents of the packet processing table. The network control device 30 is connected to each of the network apparatuses 10 via a control line 5. The network control device 30 has a function of setting the packet processing table of each network apparatus 10 via the control line 5. The network control device 30 is able to appropriately control network communication by setting the packet processing table, thereby controlling operation of the network apparatuses 10.

The Open flow (refer to http://www.openflowswitch.org/) is an example of the interface system for achieving the above-mentioned processing between the network control device 30 and the network apparatus 10. In this case, “Open flow Controller” is the network control device 30 and the “Open flow Switch” is each network apparatus 10.

The network system 1 according to the present exemplary embodiment is applied to, for example, a data center.

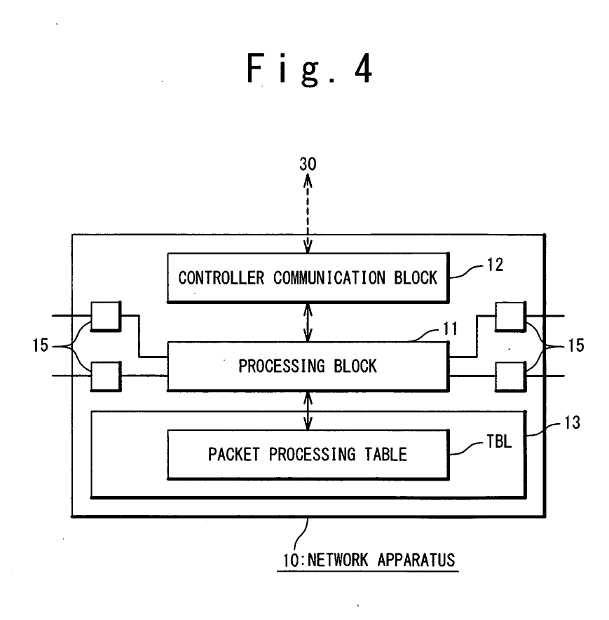

FIG. 4 is a block diagram showing an example of a configuration of the network apparatus 10. The network apparatus 10 includes a processing block 11, a controller communication block 12, a storage block 13 and a plurality of ports 15. The port 15 that receives a packet from outside is an input port and the port 15 that outputs a packet to the outside is an output port. The processing block 11 executes main packet processing such as packet transfer from the input port to the output port. The controller communication block 12 is connected to the network control device 30 via the control line 5 and acts as an interface for communication with the network control device 30.

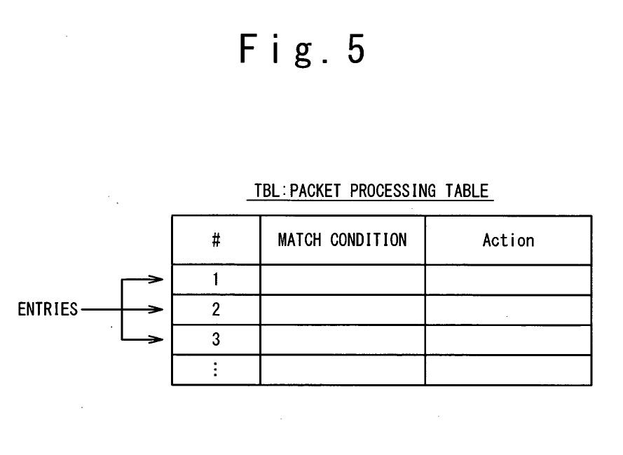

The storage block 13 stores a packet processing table TBL as shown in FIG. 5. As shown in FIG. 5, the packet processing table TBL has at least one entry and each entry indicates “match condition” and “action”. The “match condition” is composed of a combination of parameters including the input port, an originating MAC address, a destination MAC address, an originating IP address, a destination IP address, an originating port number and a destination port number. The “action” indicates “operation” performed with respect to the packet matching the match condition.

When receiving a packet through the input port, the processing block 11 refers to the packet processing table TBL stored in the storage block 13. Then, based on header information of the received packet and the like, the processing block 11 examines whether or not the received packet matches the match condition of any of the entries. That is, the processing block 11 retrieves the entry matching the received packet from the packet processing table TBL. When the received packet matches the match condition of any of the entries, the processing block 11 performs the “operation” designated as the action of the concerned entry with respect to the received packet.

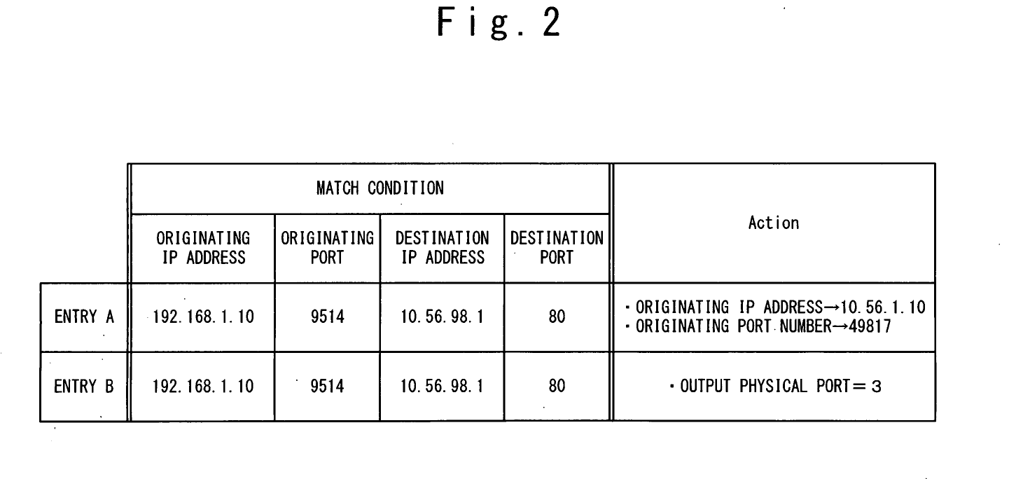

In the case of the entry A shown in FIG. 2, the “operation” is “to rewrite the originating IP address to “10.56.1.10” and the originating port number to “49817””. In the case of the entry B, the “operation” is “to transmit the packet from the port 3”. A parameter referred or rewritten in such an operation is hereinafter referred to as “operational parameter”. In the case of the entry A shown in FIG. 2, the “operational parameter” is the originating IP address and the originating port number. In the case of the entry B, the “operational parameter” is the output physical port.

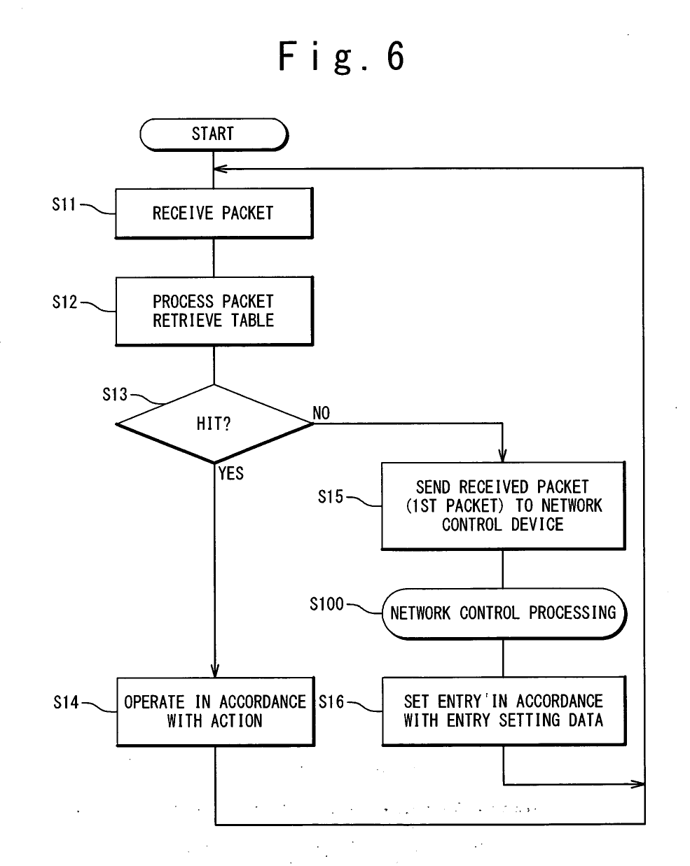

FIG. 6 is a flow chart showing processing in the network apparatus 10 according to the present exemplary embodiment. The network apparatus 10 receives a packet in a certain flow (Step S11). Specifically, the processing block 11 receives the packet through an input port. When receiving the packet from the input port, the processing block 11 extracts header information of the received packet. Then, the processing block 11 uses the extracted header information and the input port as retrieval keys to retrieve an entry matching the received packet from the packet processing table TBL (Step S12).

If an entry matching the received packet exists in the packet processing table TBL (yes in Step S13), the processing block 11 performs the “operation” designated as the action in the hit entry with respect to the received packet (Step S14). On the contrary, if an entry matching the received packet does not exist in the packet processing table TBL (No in Step S13), the received packet is a “first packet”. In this case, the processing block 11 transmits the first packet (or header information of the first packet) to the network control device 30 through the controller communication block 12 and the control line 5 (Step S15).

The network control device 30 receives the first packet (or header information of the first packet) from the network apparatus 10. The network control device 30 executes a flow identification based on the header information of the first packet and determines the contents of processing applied to the packet train in the identified flow. Specifically, the network control device 30 applies a necessary network control function to the flow. As a result, necessary contents of the entry, which are to be set in the packet processing table TBL of the network apparatus 10, are determined. The data representing the entry contents to be set is hereinafter referred to as “entry setting data”. That is, the network control device 30 performs the necessary network control function and creates the entry setting data. Then, the network control device 30 transmits the entry setting data to the necessary network apparatus 10 via the control line 5. Details of such network control processing (Step S100) by means of the network control device 30 will be described later.

Each network apparatus 10 that receives the entry setting data from the network control device 30 sets (adds or changes) the entry necessary for its own packet processing table TBL according to the entry setting data (Step S16). Further, the network control device 30 returns the first packet to the network apparatus 10. After that, the first packet and subsequent packets in the same flow are processed by each network apparatus 10 at high speed without passing through the network control device 30.

### 2. Network Control Device

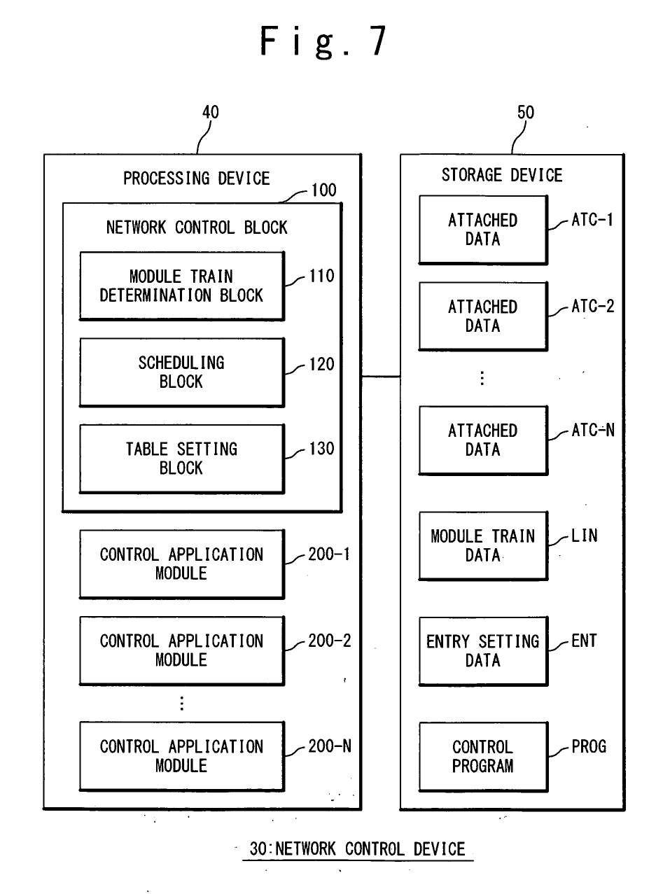

The network control device 30 according to the present exemplary embodiment will be described below in detail. FIG. 7 is a block diagram showing an example of a configuration of the network control device 30. The network control device 30 includes a processing device 40 and a storage device 50. The processing device 40 includes a CPU (Central Processing Unit) and executes various types of data processing. The storage device 50 has a RAM (Random Access Storage device), an HDD (Hard Disk Drive) or the like.

The processing device 40 has a network control block 100 and a plurality of control application modules 200.

The network control block 100 includes a module train determination block 110, a scheduling block 120 and a table setting block 130. These functional blocks execute network control processing (Step S100) described later in detail. These functional blocks are realized by execution of a control program PROG by means of the processing device 40. The control program PROG is a computer program executed by the network control device 30 (processing device 40) and is stored in the storage device 50. The control program PROG may be stored in a computer-readable recording medium. The processing device 40 executes the control program PROG, thereby achieving the network control processing (Step S100) according to the present exemplary embodiment.

The plurality of control application modules 200 have different network control functions, respectively. In an example shown in FIG. 7, N types of (N is an integer of 2 or more) control application modules 200-1 to 200-N are provided. Each of the control application modules 200 is realized by execution of application software having a corresponding network control function by means of the processing device 40. Each of the control application modules 200 performs its own network control function, thereby determining the contents of the above-mentioned “operation” performed with respect to a target packet. That is, each control application module 200 determines the contents of the above-mentioned “operation” according to its own network control function.

Examples of the network control functions include “shortest path switching”, “NAPT (Network Address Port Translation)” and “load balancing”. The “shortest path switching” is a function for achieving packet transmission along a shortest path. The “NAPT” is a function of performing packet address/port conversion. The “load balancing” is a function of performing load distribution.

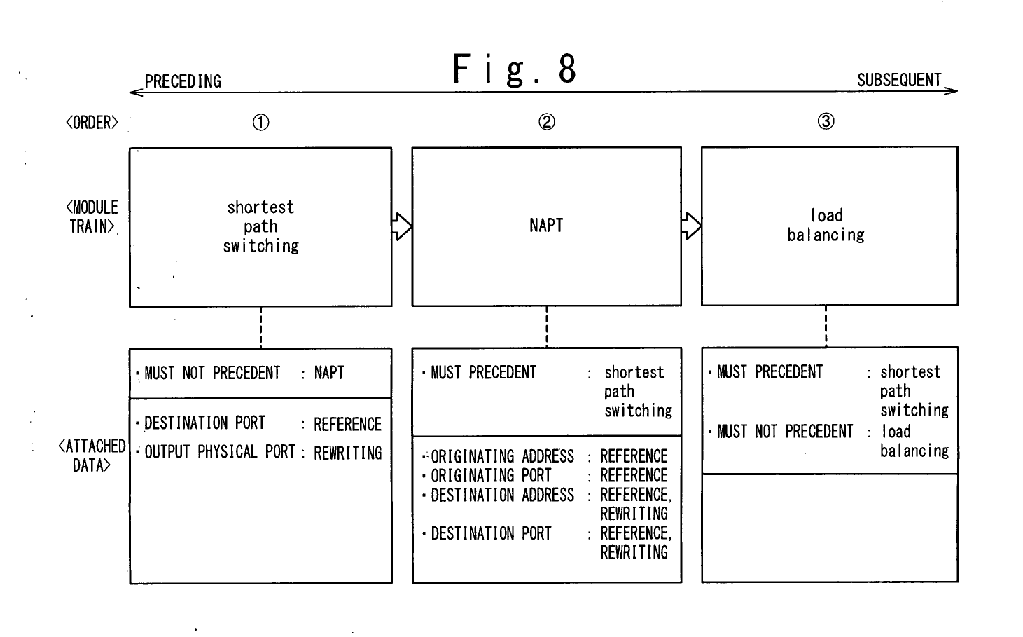

Here, referring to FIG. 8, the “module train” according to the present exemplary embodiment will be described. The module train is configured of at least one of the plurality of control application modules 200. In an example shown in FIG. 8, the module train is configured of the following three control application modules 200: (1) the shortest path switching; (2) the NAPT; and (3) the load balancing.

In the module train, the order by which the control application modules 200 as constituents are to be performed is specified. In the example shown in FIG. 8, (1) the shortest path switching, (2) the NAPT and (3) the load balancing are performed in this order. In terms of the execution order, “preceding” and “subsequent” can be defined. A module performed earlier (in a previous stage) than the other control application modules 200 is referred to as a “preceding module”. A module performed later (in a subsequent stage) than the other control application modules 200 is referred to as a “subsequent module”. For example, when viewed from (2) the NAPT, (1) the shortest path switching is a preceding module and (3) the load balancing is a subsequent module.

As described later, the execution order in the module train is appropriately determined in advance. It can be said that the module train has “a series of network control functions” corresponding to the control application modules 200 as constituents and the execution order. When the module train is executed, that is, the control application modules 200 are executed in the specified order, “the series of network control functions” are applied to the target packet. As a result, “a series of operations” corresponding to “the series of network control functions” are determined. In the network apparatus 10, “the series of operations” are performed with respect to the packet.

Here, inconsistency must not occur in “the series of operations” performed with respect to the packet. For example, given that a certain operational parameter is rewritten by a certain operation. In this case, a situation where the next operation becomes impossible caused by the rewriting should be avoided. In other words, the consistency must be insured for “the series of operations”. To insure such consistency, “attached data” as shown in FIG. 8 is used.

The attached data is prepared for each of the control application modules 200 in advance. Each piece of attached data indicates the “operational parameter” referred or rewritten in the “operation” determined by the corresponding control application module 200. For example, the attached data related to the shortest path switching indicates “destination address reference” and “output physical port: rewriting”. This means that, in the operation determined by the shortest path switching, the destination address of the packet is referred and the output physical port is rewritten.

Further, each attached data also indicates dependence between the corresponding control application module 200 and the other control application module 200. For example, the attached data related to the shortest path switching indicates “must not precedent: NAPT”. This means that the NAPT must not be performed earlier than the shortest path switching. The attached data related to the NAPT indicates “must precedent: shortest path switching”. This means that the shortest path switching must be performed earlier than the NAPT.

Referring to FIG. 7 again, the storage device 50 stores attached data ATC, module train data LIN, entry setting data ENT and control program PROG. The attached data ATC is as described above and is prepared for each of the control application modules 200 in advance. In the example shown in FIG. 7, a plurality of pieces of attached data ATC-1 to ATC-N are prepared for the plurality of control application modules 200-1 to 200-N, respectively. The module train data LIN is data representing the module train as shown in FIG. 8. Typically, the module train data LIN is given as a linear list having reference to constituents of the module train as a node. As described above, the entry setting data ENT is data representing contents of the entry to be set in the network apparatus 10.

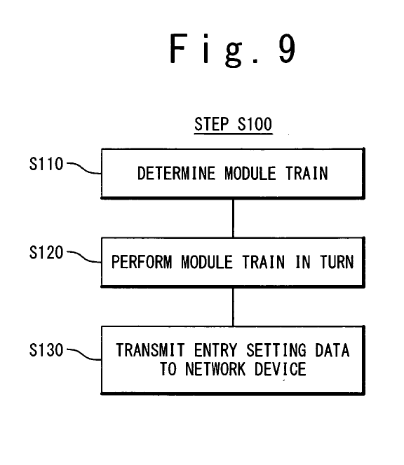

FIG. 9 is a flowchart showing network control processing (Step S100) by the network control block 100. Step S110:

The network control block 100 receives a target packet. Typically, the target packet is the above-mentioned “first packet” transmitted from the network apparatus 10. However, the,target packet is not limited to the first packet. In response to the target packet, the module train determination block 110 determines the “module train” applied to the target packet.

At this time, the execution order of the control application modules 200 constituting the module train must be determined so as not to cause inconsistency in “the series of operations” determined by execution of the module train. For this reason, the module train determination block 110 refers to the necessary attached data ATC stored in the storage device 50. The module train determination block 110 is able to determine the module train that does not cause inconsistency in dependence between the control application modules 200, and the operational parameters by appropriately referring to the attached data ATC. In other words, the module train determination block 110 is able to determine a suitable module train so as not to cause inconsistency in “the series of operations” performed with respect to the target packet. A method of determining the module train will be described later in the section 3 in more detail.

The module train determination block 110 creates the module train data LIN indicating the determined module train and stores the module train data. LIN in the storage device 50.

### Step S120:

The scheduling block 120 reads the module train data LIN from the storage device 50. Then, the scheduling block 120 calls the control application modules 200 designated by the module train in turn according to the module train data LIN and carries out the module train. At this time, the operational parameter is passed between the control application modules 200 as required. By carrying out the module train in this manner, the series of operations with insured consistency for the target packet is determined. The scheduling block 120 creates “a single piece of entry setting data ENT” indicating a series of operations with insured consistency. Then, the scheduling block 120 stores the single piece of entry setting data ENT created with respect to the target packet in the storage device 50.

### Step S130:

The table setting block 130 reads the single piece of entry setting data ENT from the storage device 50. Then, the table setting block 130 transmits the single piece of entry setting data ENT to the necessary network apparatus 10.

Each network apparatus 10 that receives the single piece of entry setting data ENT from the network control device 30 sets a single entry in its own packet processing table TBL according to the single piece of entry setting data ENT (Step S16). The consistency of “the series of operations” designated by the single entry is insured. Accordingly, desired packet processing corresponding to the combination of the plurality of network control functions can be achieved without any inconsistency.

### 3. Determination of Module Train (Step S110)

The method of determining the module train by the module train determination block 110 will be described below in more detail.

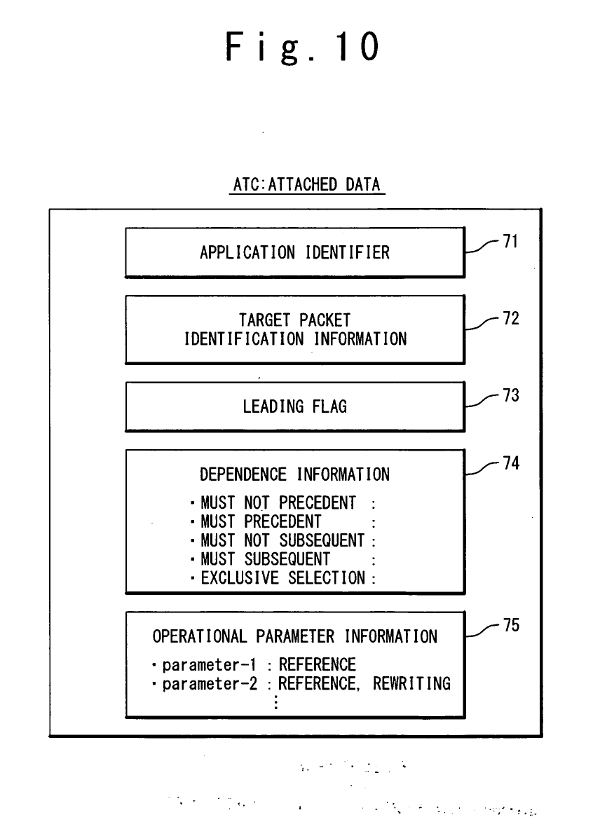

FIG. 10 is a conceptual diagram showing the attached data ATC according to the present exemplary embodiment. The attached data ATC related to a certain control application module 200 includes an application identifier 71, target packet identification information 72, a leading flag 73, a dependence information 74 and operational parameter information 75. The application identifier 71 is an identifier of the concerned control application module 200. The target packet identification information 72 is identification information of the target packet to which the concerned control application module 200 is applied. The leading flag 73 indicates whether or not the concerned control application module 200 should be executed first among the control application modules 200 which are required to be applied to the concerned target packet.

The dependence information 74 indicates dependence between the concerned control application module 200 and other control application module 200. The other control application module 200 designated as “must not precedent” must not be a preceding module for the concerned control application module 200. The other control application module 200 designated as “must precedent” must be a preceding module for the concerned control application module 200. The other control application module 200 designated as “must not subsequent” must not be the subsequent module for the concerned control application module 200. The other control application module 200 designated as “must subsequent” must be the subsequent module for the concerned control application module 200. The other control application module 200 designated as “exclusive selection” must not be included in the module train along with the concerned control application modules 200.

The operational parameter information 75 indicates the “operational parameter” referred or rewritten in the “operation” determined by the concerned control application modules 200. The operational parameter is a packet protocol field and typically includes an arrival physical port and a transmission physical port of the packet on the network apparatus 10; an source address, a destination address, a protocol type and a VLAN tag in an Ethernet frame; an originating address, a destination address and a protocol number of an IPV4 packet; an originating port and a destination port of TCP and UDP.

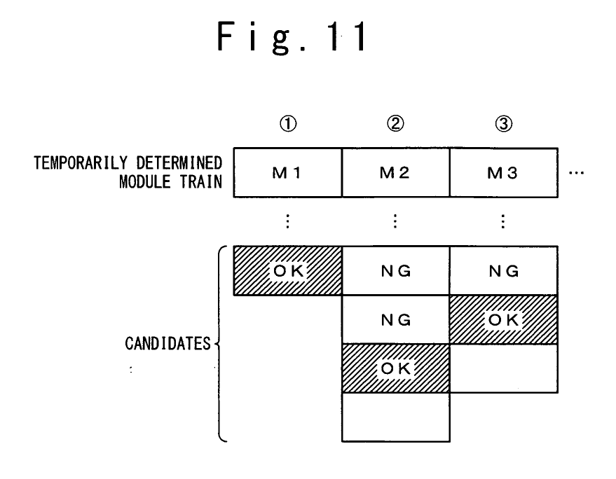

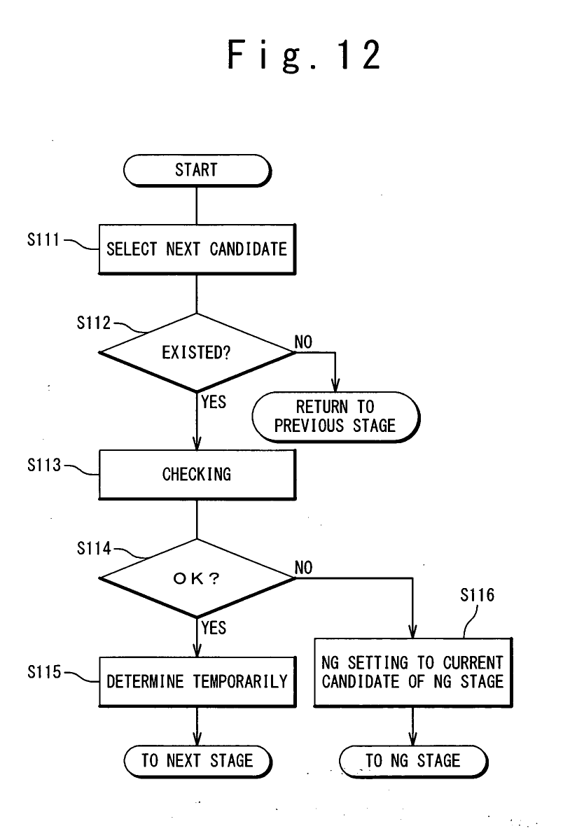

FIG. 11 conceptually shows Step S110 in the present exemplary embodiment. FIG. 12 is a flow chart showing Step S110. The module train is sequentially determined from the leading module (the module performed first). A partially determined module train is hereinafter referred to as a “temporarily determined module train”.

In determining a module in a certain stage, a module as a candidate is hereinafter referred to as a “candidate module”. The candidate module is the control application module 200 about which the target packet identification information 72 in the corresponding attached data ATC matches the target packet. In determining the leading module, the module about which the leading flag 73 is set in the corresponding attached data ATC is the candidate module.

In determining a module in a certain stage, first, one candidate module is selected (Step Sill; Yes in Step S112). Subsequently, by referring to the attached data ATC of the selected candidate module and each module constituting the temporarily determined module train, the candidate module is checked against each module constituting each determined module train (S113). As a result of the checking, when no inconsistency occurs in the operational parameter and dependence (Yes in Step S114), the candidate module is adopted and added to the end of the temporarily determined module train (Step S115). Then, processing proceeds to module determination in the next stage.

On the contrary, as a result of the checking, inconsistency may occur somewhere (No in Step S114). The NG stage in which the inconsistency occurs may be the stage being currently considered or a stage in the temporarily determined module train. In this case, the module in the NG stage is set to “NG (refer to FIG. 11)” (Step S116). Then processing returns to module determination in the NG stage. In the module determination in the NG stage, the module already set to “NG” is not selected as the candidate module.

When there is no unchecked candidate module (No in Step S112), processing returns to module determination in the previous stage. The module temporarily determined in the previous stage is set to “NG” and the next candidate module is selected.

By recursively executing such processing, the module train is determined.

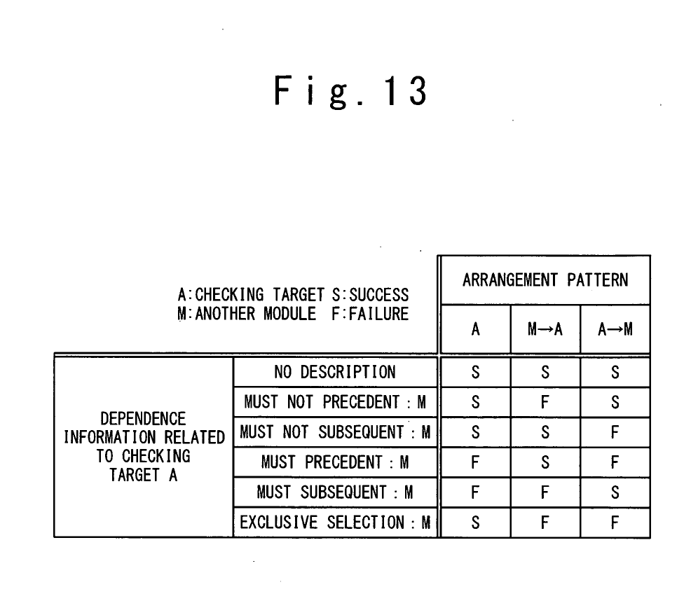

The “Checking” in Step S113 is as follows. FIG. 13 shows checking of dependence based on dependence information 74. In FIG. 13, a module A and a module M are different from each other. Here, the dependence information 74 in the attached data ATC related to the module A is referred for checking. The checking result varies depending on description of the dependence information 74 in the attached data ATC related to the module A and arrangement pattern (sequence context) of the module A and the module M. The checking result S represents “success” and the checking result F represents “failure”.

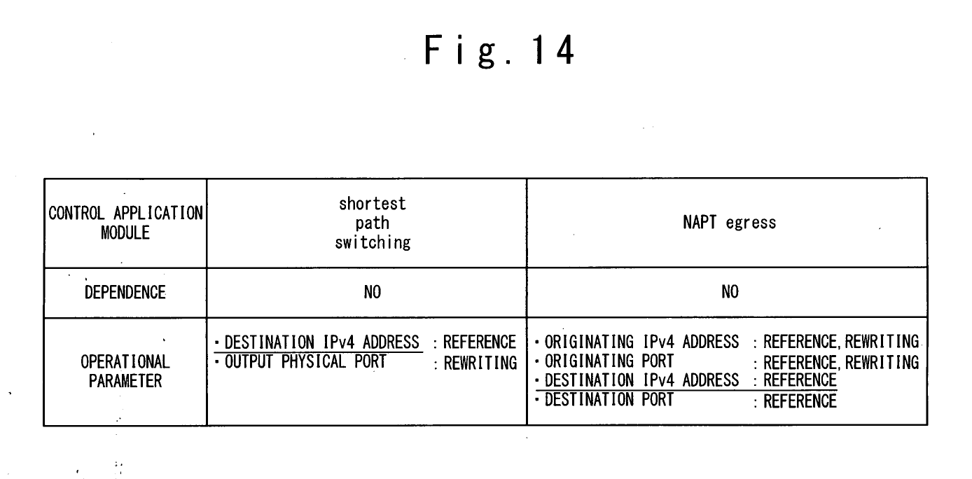

In Step S113, consistency of the operational parameter is also checked. When interference of the operational parameter occurs between different modules, the series of operations performed with respect to the packet may bring about an unintended result. Accordingly, it is confirmed whether or not inconsistency of the processing to the operational parameter (reference, rewriting) occurs between the temporarily determined module train and the candidate module. FIGS. 14 to 16 show some examples.

FIG. 14 shows checking between the “shortest path switching” and the “NAPT egress”. For the dependence, nothing is specified. For the operational parameter, “reference to destination IPv4 address” is specified in both the modules. Since only “reference” is specified in both the modules, the series of operations does not bring about an unintended result irrespective of the execution order. Accordingly, the checking result is success (S).

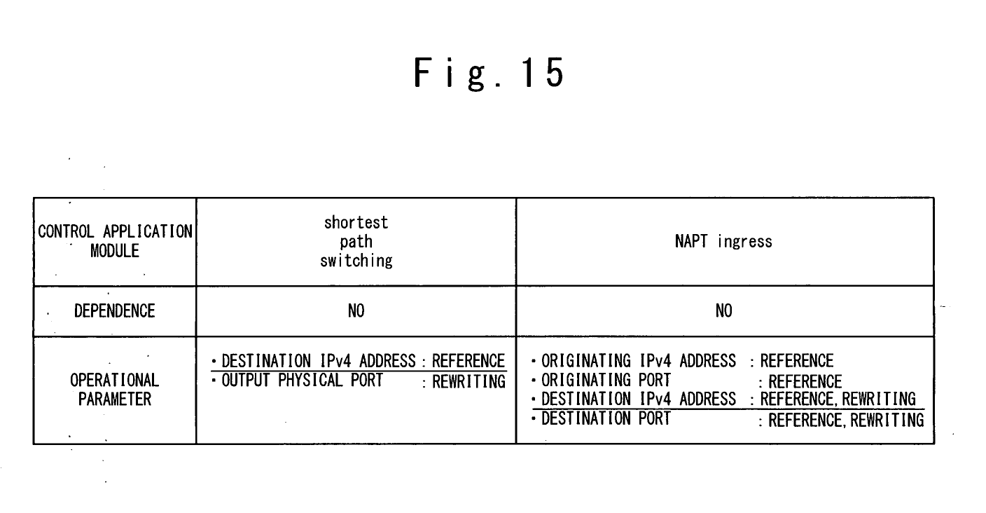

FIG. 15 shows checking between the “shortest path switching” and the “NAPT ingress”. For the dependence, nothing is specified. For the operational parameter, “reference to destination IPv4 address” is specified in the “shortest path switching” and “reference to destination IPv4 address and rewriting” is specified in the “NAPT ingress”. In this case, since rewriting of the destination IPv4 address occurs, the series of operations may bring about an unintended result depending on the execution order. When there is a possibility that the unintended result occurs, the checking result is failure (F).

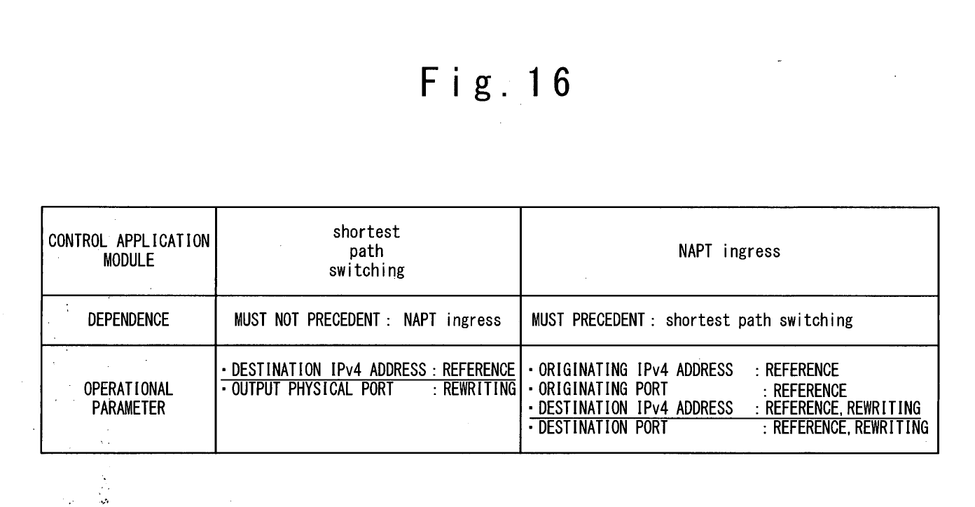

FIG. 16 shows the case where dependence is also specified in the example shown in FIG. 15. Specifically, it is prohibited that the “NAPT ingress” is executed before the “shortest path switching”. Also, it is specified that the “shortest path switching” is executed before the “NAPT ingress”. In this case, rewriting of the destination IPv4 address does not affect the “shortest path switching”. That is, the series of operations does not bring about an unintended result. Accordingly, the checking result is success (S).

Some exemplary embodiments of the present invention have been described referring to the accompanying drawings. However, the present invention is not limited to the above-mentioned exemplary embodiments and may be appropriately modified by those skilled in the art so as not to deviate from the subject matter.

This application is based upon and claims the benefit of priority from Japanese patent application No. 2009-286188, filed on Dec. 17, 2009, the disclosure of which is incorporated herein its entirety by reference.

What is claimed is:

1. A network system comprising:
a network apparatus having a packet processing table; and
a network control device connected to the network apparatus,
wherein each entry of the packet processing table indicates a match condition and an operation executed on a packet being matched to the match condition,
the network apparatus is configured to set said each entry in response to an entry setting data transmitted from the network control device,
the network apparatus is configured to refer to the packet processing table when receiving the packet, and execute the operation designated by a certain entry in the packet processing table on the received packet when the received packet is matched to the match condition of the certain entry, and
the network control device comprises:
a plurality of control application modules having a plurality of network control functions different from each other respectively, and configured to determine a content of the operation correspondingly to the plurality of network control functions,
a module train determination block configured to determine a module train being composed of at least one of the plurality of control application modules and has a sequence of network control functions applied to a target packet;
a scheduling block configured to execute the module train in turn and generate a single entry setting data indicating a sequence of the operation which corresponds to the sequence of network control devices;
a table setting block configured to transmit the single entry setting data to the network apparatus; and
a storage device configured to store a plurality of attached data relating to the plurality of control application modules respectively, and
each of the plurality of attached data indicates an operational parameter being referred or rewritten when the operation determined by a corresponding control application module among the plurality of control application modules is executed, and
the module train determination block is configured to determine the module train such that an inconsistency does not occur in the sequence of operations which are executed on the target packet by referring to said each attached data.

2. The network system according to claim 1, wherein said each attached data further indicates a dependency between the corresponding control application module and another control application module among the plurality of control application modules, and
the module train determination block is configured to determine the module train such that the dependency is satisfied by referring to said each attached data.

3. The network system according to claim 1, wherein the network device is configured to transmit the received packed to the network control device as the target packet when the received packet is not matched with the match condition of any entry in the packet processing table.

4. A network control device capable of being connected to a network apparatus, wherein the network apparatus has a packet processing table, and
each entry of the packet processing table indicates a match condition and an operation executed on a packet being matched to the match condition,
the network apparatus is configured to set said each entry in response to an entry setting data transmitted from the network control device,
the network apparatus is configured to refer to the packet processing table when receiving the packet, and execute the operation designated by a certain entry in the packet processing table on the received packet when the received packet is matched to the match condition of the certain entry, and
the network control device comprises:
a plurality of control application modules having a plurality of network control functions different from each other respectively, and configured to determine a content of the operation correspondingly to the plurality of network control functions,
a module train determination block configured to determine a module train being composed of at least one of the plurality of control application modules and has a sequence of network control functions applied to a target packet;
a scheduling block configured to execute the module train in turn and generate a single entry setting data indicating a sequence of the operation which corresponds to the sequence of network control devices;
a table setting block configured to transmit the single entry setting data to the network apparatus; and
a storage device configured to store a plurality of attached data relating to the plurality of control application modules respectively, and
each of the plurality of attached data indicates an operational parameter being referred or rewritten when the operation determined by a corresponding control application module among the plurality of control application modules is executed, and
the module train determination block is configured to determine the module train such that an inconsistency does not occur in the sequence of operations which are executed on the target packet by referring to said each attached data.

5. The network control device according to claim 4, wherein said each attached data further indicates a dependency between the corresponding control application module and another control application module among the plurality of control application modules, and
the module train determination block is configured to determine the module train such that the dependency is satisfied by referring to said each attached data.

6. A control method of a network apparatus, wherein the network apparatus has a packet processing table,
wherein each entry of the packet processing table indicates a match condition and an operation executed on a packet being matched to the match condition,
the network apparatus is configured to set said each entry in response to an entry setting data transmitted from the network control device,
the network apparatus is configured to refer to the packet processing table when receiving the packet, and execute the operation designated by a certain entry in the packet processing table on the received packet when the received packet is matched to the match condition of the certain entry, and
a plurality of control application modules included in the network control device have a plurality of network control functions different from each other respectively, and configured to determine a content of the operation correspondingly to the plurality of network control functions,
wherein the control method comprises:
determining a module train being composed of at least one of the plurality of control application modules and has a sequence of network control functions applied to a target packet;
executing the module train in turn and generating a single entry setting data indicating a sequence of the operation which corresponds to the sequence of network control devices; and
transmitting the single entry setting data to the network apparatus, and
the determining the module train comprises:
reading out a plurality of attached data relating to the plurality of control application modules respectively, wherein each of the plurality of attached data indicates an operational parameter being referred or rewritten when the operation determined by a corresponding control application module among the plurality of control application modules is executed, and
executing determination of the module train such that an inconsistency does not occur in the sequence of operations which are executed on the target packet by referring to said each attached data.

7. The control method according to claim 6, wherein said each attached data further indicates a dependency between the corresponding control application module and another control application module among the plurality of control application modules, and
said determining the module train further comprises:
determining the module train such that the dependency is satisfied by referring to said each attached data.

8. A computer-readable non-transitory medium having executable code to cause a computer of a network control device to execute control processing of a network apparatus, wherein the network apparatus has a packet processing table,
each entry of the packet processing table indicates a match condition and an operation executed on a packet being matched to the match condition,
the network apparatus is configured to set said each entry in response to an entry setting data transmitted from the network control device,
the network apparatus is configured to refer to the packet processing table when receiving the packet, and execute the operation designated by a certain entry in the packet processing table on the received packet when the received packet is matched to the match condition of the certain entry, and
a plurality of control application modules included in the network control device have a plurality of network control functions different from each other respectively, and configured to determine a content of the operation correspondingly to the plurality of network control functions,
wherein the control processing comprises:
determining a module train being composed of at least one of the plurality of control application modules and has a sequence of network control functions applied to a target packet;
executing the module train in turn and generating a single entry setting data indicating a sequence of the operation which corresponds to the sequence of network control devices; and
transmitting the single entry setting data to the network apparatus, and
the determining the module train comprises:
reading out a plurality of attached data relating to the plurality of control application modules respectively, wherein each of the plurality of attached data indicates an operational parameter being referred or rewritten when the operation determined by a corresponding control application module among the plurality of control application modules is executed, and
executing determination of the module train such that an inconsistency does not occur in the sequence of operations which are executed on the target packet by referring to said each attached data.

9. The computer-readable non-transitory medium according to claim 8, wherein said each attached data further indicates a dependency between the corresponding control application module and another control application module among the plurality of control application modules, and
said determining the module train further comprises:
determining the module train such that the dependency is satisfied by referring to said each attached data.
